(19) United States
(12) Patent Application Publication
(10) Pub. No.: US 2005/0135195 A1
(43) Pub. Date: Jun. 23, 2005

(54) Rescue/emergency timepiece

(76) Inventor: James Kreidler, Palm Beach Gardens, FL (US)

Correspondence Address: MCHALE & SLAVIN, P.A., 2855 PGA BLVD, PALM BEACH GARDENS, FL, 33410, US

(21) Appl. No.: 10/964,247

(22) Filed: Oct. 12, 2004

Related U.S. Application Data
(63) Continuation-in-part of application No. 10/150,423, filed on May 17, 2002, now abandoned.

(51) Int. Cl. G04C 19/00; G04F 8/00

(52) U.S. Cl. 368/107

(57) ABSTRACT

The present invention is directed to a rescue/emergency timepiece for tracking the time in which a victim remains at the scene of an emergency prior to transportation to a medical facility. The timepiece includes a first predetermined timer for trauma type emergencies. The first timer is started by operation of a single button to begin a count-up timer. At the conclusion of a predetermined amount of time, preferably ten minutes, an alarm is operated to alert the emergency worker of the elapsed time. The timepiece also includes a second predetermined timer for non-trauma type emergencies. The second timer is started by operation of a single button to begin a second count-up timer. At the conclusion of a predetermined amount of time, preferably twenty minutes, an alarm is operated to alert the emergency worker.

### REFERENCE TO RELATED APPLICATIONS

This application is a continuation-in-part of Ser. No. 10/150,423, filed May 17, 2002, the contents of which are herein incorporated by reference in their entirety.

### FIELD OF THE INVENTION

This invention relates to a timepiece particularly suited for rescue/emergency workers; more particularly the instant invention relates to a timepiece that includes at least two predetermined timers useful in the resuscitation, stabilization, and transport of medical patients from an accident or injury site to a medical care facility.

### BACKGROUND OF THE INVENTION

It is frequently necessary to transport medical patients from the site of an accident or injury to a hospital. For example, persons suffering from various medical emergency conditions such as heart attacks, and strokes or in times of natural disaster, e.g. tornadoes and earthquakes. Other emergencies result from airliner, train, and automobile accidents, and criminal or terrorist attacks. Victims must be transported quickly to a medical facility. In these situations a few minutes can mean the difference between life and death. In other cases, the same few minutes can mean the difference between a relatively full recovery and a life of impairment and disability. In fact, the first hour following a medical trauma is sometimes called the “golden hour”.

The traditional approach applied by paramedical personnel has been to stabilize the patient in the field. The current goal of the paramedics is to stabilize a trauma patient for transport within 10 minutes of on-scene time, and within 20 minutes of on-scene time for all other medical emergencies. Within this time the patient should be stabilized, placed upon a gurney or stretcher, and transported via ambulance or helicopter to a medical facility for further treatment.

While most traditional timepieces such as wristwatches, provide a stopwatch or event timing feature they have proven impracticable for emergency personnel. Such prior art wristwatches require a user to manipulate a specific sequence of buttons to setup and/or start a simple count up timer. In addition, these timepieces often do not provide an alarm function that operates in conjunction with the timer. Timepieces that provide an alarm function operating in conjunction with timers require an additional sequence of buttons to be manipulated for operation.

### PRIOR ART

Various timepiece devices have been proposed in the prior art. These devices generally do not include preset timers each having a dedicated button for operation of a respective timer.

U.S. Pat. No. 6,144,619 teaches an improved timepiece to be worn by pilots of aircraft which provides a means to alert the pilot of multiple sequenced event occurrences via multiple alarm means including visual, auditory, and tactile ability. The six in-flight timers, accessible through four buttons, allow the pilot comprehensive user programmable features in order to meet the needs of a given flight. This electronic watch is specifically designed for pilots to address the plurality of in-flight timing needs.

U.S. Pat. No. 4,523,857 teaches an analog electronic timepiece that has a plurality of functions, each driven independently by a dedicated step motor. A stem, pullable to three positions and a plurality of pushbuttons control operation of timepiece functions. Each indicator hand may be set to zero independently by operation of an external button when the electronic circuits indicate that the respective hand should be at the zero position.

U.S. Pat. No. 6,661,743 teaches a watch display that includes a plurality of display arrays, such as a time display section, a chronological display section, and a chronological split display section. An upper or lower polarizer is provided with a light modulating section having a reflection type polarizer. To display only the time, the chronological display section and the chronological split display section are shielded by the light modulating section. For chronological display, the chronological display section is lit and the chronological split display is displayed or shielded as required by a shutter function.

U.S. Pat. No. 5,745,439 teaches a paging device in combination with an accurate stopwatch including a stopwatch timer block supported by latent processor element resources. The user directly manipulates, e.g., starts and stops, the timer block without processor element intervention. The processor element is thereby free to service higher priority tasks, e.g., receipt of paging information, and collects stopwatch timer block data at a lower priority level.

U.S. Pat. No. 6,643,224 teaches a timepiece in which a first liquid crystal display panel and a second liquid crystal display panel, each of which is constituted by sealing a liquid crystal layer in a gap between a pair of substrates formed with electrodes on opposed inner faces thereof respectively, are arranged in a case body having a cover glass with at least portions thereof overlapping. A first polarizing film is provided on an upper substrate of the first liquid crystal display panel on the cover glass side, a second polarizing film is provided between the first liquid crystal display panel and the second liquid crystal display panel, and a third polarizing film is provided on the lower side of a lower substrate of the second liquid crystal display panel respectively. The second polarizing film is a reflection type polarizing film, the first polarizing film, the first liquid crystal display panel, and the second polarizing film constitutes an upper display portion, and the second polarizing film, the second liquid crystal display panel, and the third polarizing film constitutes a lower display portion, so that at least the lower display portion performs display on the time.

U.S. Pat. No. 5,619,477 teaches a clock having at least one display unit for the real time, at least one input unit for at least one adjustable set-time, if necessary linked to a date, that can be stored in a memory and that triggers a process when it is attained, as well as at least one display unit for the set-time(s). The input unit has at least three main input means. Each main input means allows a moment in time located in the future with respect to the time presently displayed in the set-time display unit to be reached, starting from the real time or from an adjusted set-time that has been programmed immediately beforehand with the same or another main input means. Said future moment in time represents an integral multiple or an integral fraction of an hour and/or the beginning of an explicitly named set period in time adapted to our natural time perception conditioned by culture and tradition.

Although the specialized timepieces listed above do have the ability to act as a stopwatch or sound an alarm, they also have a number of disadvantages and shortcomings that have proven impracticable for emergency personnel. The complexity and button manipulations required for operation of these devices limit their usefulness and the environments in which they can be utilized. In addition, some of these devices require mechanical connections for programming and risk damage to fragile connectors.

Accordingly, what is lacking in the art is a timepiece constructed specifically for emergency personnel. More specifically, the timepiece device should include at least two predetermined timers that are operable at the push of a single button. One of the timers should be configured for tracking on-scene trauma type emergencies and one of the timers should be configured for tracking the on-scene time of other medical emergencies. The timers should sound an alarm after the predetermined amount of time and thereafter continue counting up until manually stopped.

### SUMMARY OF THE INVENTION

The present invention is directed to a rescue/emergency timepiece for tracking the time in which a victim remains at the scene of an emergency prior to transportation to a medical facility. The timepiece includes a first predetermined timer for trauma type emergencies. The first timer is started by operation of a single button to start a count-up timer. At the conclusion of a predetermined amount of time, preferably ten minutes, an alarm is operated to alert the emergency worker of the elapsed time. In the event that the trauma victim is still at the scene, the timer continues counting until manually stopped. This allows the emergency personnel to inform hospital personnel of the complete time required to stabilize and transport the victim. The timepiece also includes a second predetermined timer for other non-trauma type emergencies. The second timer is started by operation of a single button to start a second count-up timer. At the conclusion of a predetermined amount of time, preferably twenty minutes, an alarm is operated to alert the emergency worker. In the event that the emergency victim is still at the scene, the timer continues counting until manually stopped. This allows the emergency personnel to inform hospital personnel of the complete time required to stabilize and transport the victim. The alarms may be audible, visual, tactile or a suitable combination thereof.

Accordingly, it is a primary objective of the present invention to teach a timepiece for use in an medical emergency environment.

Another objective of the instant invention is to teach a timepiece having at least two predetermined timer operated alarms.

Yet another objective of the instant invention is to teach a timepiece having a single button operable timer and associated alarm for alerting emergency personnel after ten minutes of elapsed time during trauma type emergencies and rescues.

Still another objective of the instant invention is to teach a timepiece having a single button operable timer and associated alarm for alerting emergency personnel after twenty minutes of elapsed time during non-trauma type emergencies and rescues.

Other objectives and advantages of this invention will become apparent from the following description taken in conjunction with the accompanying drawings wherein set forth, by way of illustration and example, certain embodiments of this invention.

The drawings constitute a part of this specification and include exemplary embodiments of the present invention and illustrate various objectives and features thereof.

### BRIEF DESCRIPTION OF THE DRAWINGS

FIG. 1 is a front view illustrating the instant invention timepiece;

FIG. 2 is a rear view illustrating the instant invention timepiece.

### DETAILED DESCRIPTION OF THE PREFERRED EMBODIMENT

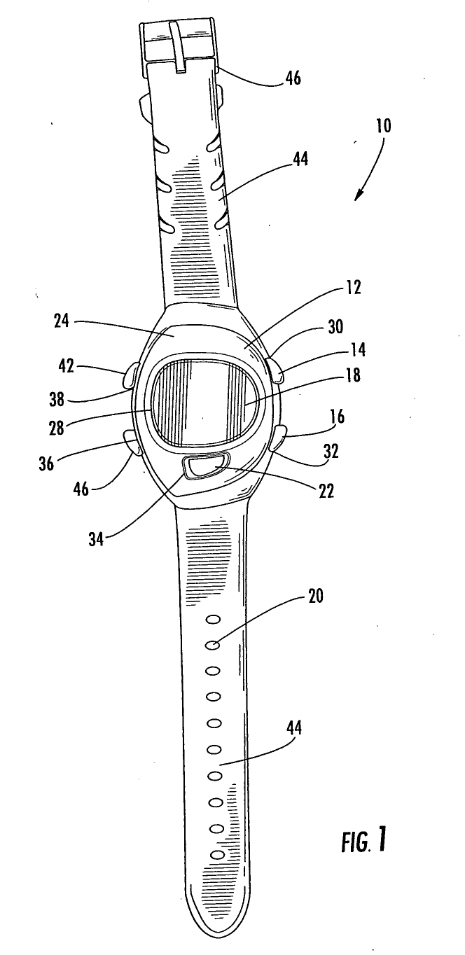

Referring to FIG. 1, a timepiece apparatus 10 useful for emergency medical personnel for tracking the time in which a trauma or non-trauma victim remains at the scene of an emergency prior to transportation to a medical facility.

The timepiece apparatus 10 includes a timepiece housing 12 for containing electronic circuitry (not shown), a first timer switch 14, a second timer switch 16, a digital display 18, a means for securing the timepiece to a user 20 and a back-light switch 22. These general elements will now be described in detail.

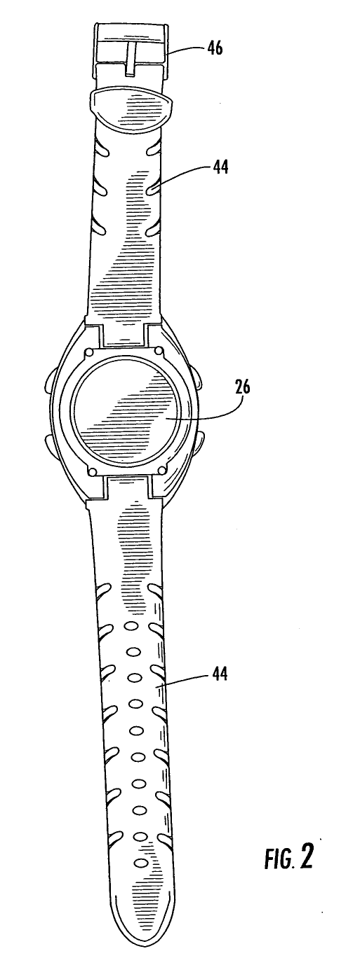

Referring to FIGS. 1 and 2, the housing 12 of the preferred embodiment is generally oval in shape. The housing may be fabricated of plastic, metal or suitable combinations thereof and may be formed into any suitable shape. The housing 12 includes a top section 24 and a bottom section 26. The top section 24 includes a display opening 28 through which the digital display 18 may be viewed. The digital display is generally either an LED or LCD display as is well known in the art, however it is also contemplated that an analog display could alternatively be utilized. The top section also includes openings 30 and 32 through which switch buttons 14 and 16 extend outwardly therethrough. The top section may further include an opening 34 through which the back-light switch 22 extends and openings 36 and 38 through which time reset buttons 40 and 42 extend outwardly therefrom.

The bottom section 26 is suitably secured to the upper section 24 by means well known in the art that may include fasteners, adhesive, press fits or suitable combinations thereof. The housing 12 includes a hollow interior suitable for the reception of electronic circuitry and a power cell (not shown), such that the circuitry may be energized by the power cell. The electronic circuitry is of a type well known in the art suitable for watches and/or timepieces and preferably includes at least two timer circuits. In the preferred embodiment one of the timer circuits is preset to 10 minutes and the other timer circuit is preset to 20 minutes. In this manner, emergency personnel may push the first timer switch 14 to start the first preset timer. The first preset timer is utilized for tracking the time a trauma victim remains at an accident scene prior to stabilization and transport to a medical facility. Likewise emergency personnel may push the second timer switch 16 to start the second preset timer. The second preset timer is utilized for tracking the time a non-trauma victim remains at an accident scene prior to stabilization and transport to a medical facility. In a most preferred embodiment the timer continues to run if the preset times elapse and the alarm is activated. This allows emergency personnel to alert hospital personnel of the entire time taken to stabilize and transfer the patient. In a most preferred embodiment the timer switches 14 and 16 are color coded for easy identification by emergency personnel. For example, the trauma timer switch 14 could be color coded red and the non-trauma switch 16 could be color coded blue for easy identification.

Still referring to FIGS. 1 and 2, the timepiece apparatus includes fastening means for securing said timepiece to a user's body illustrated herein as an adjustable wrist strap 20. The wrist strap 20 is preferably constructed and arranged for flexible or pivotable attachment to the housing 12. The strap includes an appropriate clasp or fastener 46 for adjusting its length to suit various sized individuals.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A timepiece apparatus for emergency medical personnel useful for measuring the on-scene time of a patient comprising:
a timepiece housing for containing electronic circuitry, said timepiece housing including a first timer switch extending outwardly from said housing for starting a first timer, said first timer switch operably connected to said electronic circuitry for activating a first timer;
a first timer, said first timer operably connected to said first timer switch via said electronic circuitry, said first timer constructed and arranged to operate a first alarm upon passage of a first predetermined amount of time, wherein said first predetermined amount of time is useful for measuring the on scene time of a victim involved in a trauma emergency;
a digital display operably connected to said electronic circuitry for displaying timepiece data.

2. The timepiece apparatus as set forth in claim 1 including a second timer, said second timer operably connected to a second timer switch via said electronic circuitry, said second timer switch extending outwardly from said housing for starting a second timer, said second timer constructed and arranged to operate a second alarm upon passage of a second predetermined amount of time, wherein said second predetermined amount of time is useful for measuring the on-scene time of a victim involved in a non-trauma emergency.

3. The timepiece apparatus as set forth in claim 2 wherein said first and said second alarms are audible.

4. The timepiece apparatus as set forth in claim 2 wherein said first and said second alarms are visual.

5. The timepiece apparatus as set forth in claim 2 wherein said first and said second alarms are tactile.

6. The timepiece apparatus as set forth in claim 1 wherein said first timer continues to count up after operation of said first alarm, wherein said first timer information is displayed on said digital display for communication to medical personnel.

7. The timepiece apparatus as set forth in claim 2 wherein said second timer continues to count up after operation of said second alarm, wherein said second timer information is displayed on said digital display for communication to medical personnel.

8. The timepiece apparatus as set forth in claim 1 including fastening means for securing said timepiece to a use's body.

9. The timepiece apparatus as set forth in claim 2 including fastening means for securing said timepiece to a user's body.

10. The timepiece apparatus as set forth in claim 1 wherein said first predetermined amount of time is 10 minutes.

11. The timepiece apparatus as set forth in claim 2 wherein said second predetermined amount of time is 20 minutes.

12. The timepiece apparatus as set forth in claim 1 wherein said first timer switch is color coded for easy visual identification.

13. The timepiece apparatus as set forth in claim 2 wherein said second timer switch is color coded for easy visual identification.
